(19) United States
(12) Patent Application Publication
(10) Pub. No.: US 2015/0218496 A1
(43) Pub. Date: Aug. 6, 2015

(54) SURFACTANT-CONTAINING FOAMS

(71) Applicant: Henkel AG & Co. KGaA, Duesseldorf (DE)

(72) Inventors: Peter Schmiedel, Duesseldorf (DE); Danilo Panzica, Hilden (DE); Christian Reichert, Duesseldorf (DE); Cosima Stubenrauch, Stuttgart (DE); Michael Volker, Brueggen (DE); Uwe Trebbe, Duesseldorf (DE)

(21) Appl. No.: 14/685,763

(22) Filed: Apr. 14, 2015

Related U.S. Application Data
(63) Continuation of application No. PCT/EP2013/071844, filed on Oct. 18, 2013.

(30) Foreign Application Priority Data
Oct. 22, 2012 (DE) 10 2012 219 218.2

(51) Int. Cl. C11D 17/00; C11D 3/12; C11D 11/00; C11D 3/20

(52) U.S. Cl. CPC C11D 17/00; C11D 3/2013; C11D 3/2086; C11D 3/1233; C11D 11/00; C11D 3/1213

(57) ABSTRACT

The application describes surfactant-containing foams whose liquid phases exhibit yield points, the manufacture thereof, and packaged products that contain said foams.

### FIELD OF THE INVENTION

The present invention generally relates to surfactant-containing foams, to methods for manufacturing surfactant-containing foams, and to packaged products that contain surfactant-containing foams.

### BACKGROUND OF THE INVENTION

Surfactant-containing foams are known in a very wide variety of forms. Consumers are familiar, for example, with solid, e.g. tablet-shaped or granular washing agents and with liquid or gelled cleaners for hard surfaces. Also known are agents, for example dishwashing agents or hand soaps, that are present in the liquid state in the package but that the consumer, before they are used, converts into a foam by means of a foaming dispensing device and dispenses directly into the dishwashing water or into the palm of the hand (see e.g. WO 2007/003302 A1 for dishwashing agents). Some bathroom cleansers are moreover sprayed, by means of special foam spray nozzles, directly as a foam onto the surfaces to be treated. Shaving foam is also foamed only when it is dispensed by the consumer.

The surfactant-containing foams hitherto known to consumers are accordingly always produced by the consumer only directly before utilization, from a foamable liquid product and a two-substance pump. An advantage of this administration form is that no particular demands are placed on the foamable liquid product, besides the presence of foam-forming substances such as surfactants. Almost any usual washing-agent formulation should be suitable for being converted by means of a suitable pump apparatus into a flowable foam having short-term stability. A significant disadvantage, however, is that the quantity of, for example, a washing agent required for a single washing load is so large that it cannot readily be foamed using a pump to be operated manually, since this either would be too strenuous because too many pump strokes would have to be carried out, or because the pump that would have to be used would be too expensive for disposable use and would therefore need to be used several times. It is doubtful that consumers would be willing, in order to avoid additional cost and waste, to purchase an expensive pump that they moreover would have to keep installing on new reservoir containers.

Foams are, however, of particular interest for consumers specifically in the sector of surfactant-containing agents—washing and cleaning agents on the one hand but also cosmetic items. What consumers expect from a foam is softness, smoothness, protection, and care, but also improved spot removal performance, since they assume, for example, that foam adheres more intensively or for a longer period to a stained surface than, for example, a low-viscosity liquid, and can thus act on it longer.

Because foams are thermodynamically unstable, and because low-viscosity liquids can at best be temporarily stabilized by the use of surface-active substances, it has hitherto not been possible to offer consumers a surfactant-containing foam that has long-term stability and moreover is preferably flowable.

The object of the invention is therefore to stabilize a surfactant-containing foam so that it can be presented to the consumer in “ready-to-use” packaged form.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A surfactant-containing foam whose liquid phase exhibits a yield point.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A “foam” is understood for purposes of the present invention as a dispersed system of a gas or gas mixture in a continuous liquid phase, i.e. a structure of gas-filled cells that are demarcated by liquid cell walls. For the liquid of the cell walls the term “liquid phase” is used herein.

The object of the invention is achieved by a surfactant-containing foam whose liquid phase exhibits a yield point.

It has been found, surprisingly, that a surfactant-containing foam whose liquid phase exhibits a yield point has significantly greater long-term stability, i.e. separates significantly more slowly into a liquid phase and gas phase, than a surfactant-containing foam whose liquid phase does not possess a yield point.

The yield point is the highest shear stress below which a substance behaves like an elastic solid, or conversely the lowest shear stress above which a plastic substance behaves rheologically like a liquid.

The following procedure was used in order to determine the yield point in the context of the present invention: The sample was impinged upon in the rheometer (TA Instruments model AR G2 rotary rheometer, shear-stress-controlled rheometer, 40-mm diameter cone/plate system, 2° cone angle, 20° C.) with a shear stress σ(t) rising over time. The shear stress was raised over a period of 30 minutes from the lowest possible value (e.g. 0.01 Pa) to a value above the expected yield point (e.g. 80 Pa). The deformation γ of the sample is measured as a function of this shear stress a. For evaluation, the data are plotted on a log-log graph (log γ against log σ). The yield point, if it exists, is detectable as an abrupt change in the slope of the curve. At shear stresses below the yield point the sample reacts entirely elastically, and the slope of the curve is ideally unity. At shear stresses above the yield point, viscous flow begins and the slope of the log y/log a curve abruptly increases. The yield point is determined from the intersection point of the tangents to the two curve segments.

The yield point of the liquid phase is preferably at least 0.1 Pa, particularly preferably at least 1 Pa, and in particular at least 2 Pa. In corresponding surfactant-containing foams, leakage of the liquid phase out of the cell walls is particularly well suppressed, so that the cell wall thickness is kept constant, separation of the surfactant-containing foams into liquid phase and gas phase is prevented, and the long-term stability of the surfactant-containing foams is thus increased.

A particularly advantageous and attractive aesthetic for the surfactant-containing foam, as well as a further improvement in shelf stability, can be obtained if the liquid phase intrinsically exhibits a viscosity from 0.1 to 50 Pas at a shear rate of 10 s⁻¹ and a temperature of 20° C. The viscosity of the liquid phase is particularly preferably 1 to 20 Pas, in particular 2 to 10 Pas. In such cases the surfactant-containing foam containing the liquid phase is pourable, which corresponds to a particularly preferred embodiment of the present invention, since the consumer can also dispense the foam having such a viscosity from, for example, a dimensionally stable container. Setting the viscosity in this range also contributes to stabilizing the cell walls, and thus to an increase in the long-term stability of the respective surfactant-containing foam. The viscosity of the liquid phase is determined using the same experimental setup as described above for the yield point, although the procedure uses a program and a plot in which viscosity is indicated as a function of shear rate.

In order to establish the suitable rheology for the liquid phase, i.e. in order to constitute the yield point and the suitable viscosity, the liquid phase preferably contains one or more thickeners and/or is present in the form of a liquid-crystal surfactant phase, preferably a lamellar surfactant phase.

Suitable thickeners from the group of polymers deriving from nature are, for example, agar-agar, carrageenan, tragacanth, gum arabic, alginates, pectins, polyoses, guar flour, locust bean flour, starch, dextrins, gelatin, and casein. Modified natural substances derive chiefly from the group of modified starches and celluloses; examples that may be recited here are carboxymethyl cellulose and other cellulose ethers, hydroxyethyl cellulose and hydroxypropyl cellulose, and seed flour ethers. Microfibrillar bacterial celluloses are also suitable. A large group of thickening agents that are widely used in a great variety of utilization sectors is entirely synthetic polymers such as polyacrylic and polymethacrylic compounds, vinyl polymers, polycarboxylic acids, polyethers, polyimines, polyamides, and polyurethanes. Xanthan is furthermore suitable and preferred.

Structured surfactant systems having lamellar and/or spherulitic phases are typically formed by the interaction of surfactants with dissolved electrolyte salts and/or co-surfactants.

On a microscopic scale, lamellar surfactant phases are two-phase systems in which double layers of surfactant are arranged as parallel lamellae. These lamellae alternate with an aqueous phase. Macroscopically they usually form an opaque, gel-like, single-phase system. The double layers of surfactant of a lamellar phase can be “stacked” in parallel, such that mesoscopic domains of identical orientation are present, or are spherically “wrapped.” The latter systems are referred to as “vesicles” or “spherulites.” Lamellar surfactant phases can be formed when a surfactant system is mixed with inorganic salt and optionally with a co-surfactant. At sufficiently high concentration, many surfactants form lamellar phases even without salt and co-surfactant, but these are usually too highly viscous for the present invention, and a flowable foam does not result.

It has been found, surprisingly, that as a result of the addition of selected quantities of an inorganic salt, and in certain embodiments additionally a co-surfactant, to a surfactant-containing liquid phase, a lamellar liquid phase having a yield point, which can be used to form surfactant-containing foams having long-term stability, is obtained. A “co-surfactant” is understood for purposes of the present invention as an amphiphilic molecule that comprises a hydrophilic head group which is particularly small as compared with usual surfactants, for example a fatty alcohol, a fatty acid, a monoglyceride, or a low-ethoxylated fatty alcohol having 3 or fewer mol of ethylene oxide. Co-surfactants alone are usually very poorly water-soluble, but in the presence of soluble surfactants become incorporated into their micellar aggregates and influence their shape. At suitable concentration ratios, for example, they can induce the transition into a lamellar phase.

This surfactant-containing liquid phase is capable, without the addition of a polymeric thickener, of forming a surfactant-containing foam having long-term stability. Not only does the possibility of being able to omit polymeric thickeners have the advantage that the agents can be manufactured more easily and economically, but in addition, undesired side-effects of a polymeric thickener, such as graying when treating textiles, can be avoided. In a preferred embodiment the surfactant-containing liquid phase is correspondingly free of polymeric thickeners.

In an embodiment, the surfactant-containing liquid phase having a yield point contains 8 to 25 wt % of an inorganic salt, wherein the ratio between the total quantity of anionic and nonionic surfactant contained in the liquid phase and the inorganic salt is moreover preferably in the range from 1.4:1 to 1:1.

In another embodiment the liquid phase having a yield point contains 0.5 to 10 wt % of an inorganic salt and 0.5 to 5 wt % of a co-surfactant preferably selected from the group consisting of alkoxylated C₈ to C₁₈ fatty alcohols having a degree of alkoxylation ≦3, aliphatic C₆ to C₁₄ alcohols, aromatic C₆ to C₁₄ alcohols, aliphatic C₆ to C₁₂ dialcohols, monoglycerides of C₁₂ to C₁₈ fatty acids, monoglycerol ethers of C₈ to C₁₈ fatty alcohols, and mixtures thereof.

In order to ensure, inter alia, a sufficiently high concentration of surfactant contained in the liquid phase and of other optionally contained ingredients, and thus to ensure sufficient washing, cleaning, or care-providing performance, the foam preferably contains 10 to 60% by volume gas and 40 to 90% by volume liquid phase. Particularly preferably, 20 to 50% by volume gas and 50 to 80% by volume liquid phase are contained in the foam. A product that contains less than 10% by volume gas, and should be referred to more as a liquid product having individual dispersed gas bubbles, does not, for example, have the advantage of improved adhesion to a soiled surface. In addition, the consumer does not recognize a product having less than 10% gas phase as a foam, and does not connect the appearance of a liquid product having individual dispersed gas bubbles with the properties of softness, smoothness, protection, and care, as is the case for a foam having a gas volume proportion of, for example, 20% or even 40%. Surfactant-containing foams having at least 10% by volume gas are therefore preferred. Foams that contain more than 60% by volume gas contain such a small concentration of ingredients having washing, cleaning, or care-providing activity that the desired treatment success probably will not occur, or at least it is to be assumed that it will be questioned by the consumer. The consumer no longer perceives a “dry foam” of this kind as a wet foam that can produce satisfactory cleaning or care-providing performance thanks to a large quantity of cleaning and/or care-providing substances. For these reasons, “dry foams” having less than 40% by volume liquid phase also do not represent preferred embodiments of the present invention.

For the reasons presented above, the surfactant-containing foam preferably has a density from 400 to 900 g/1, in particular from 500 to 800 g/l.

It has been found that the best possible aesthetics, corresponding to the appearance of a surfactant-containing foam, can be achieved with gas bubble sizes from 10 μm to 3 mm. With bubble sizes below 10 μm, a viewer can no longer detect the bubbles such with the naked eye. The perception then corresponds more to a homogeneous paste. With a bubble size of more than 3 mm, in particular at lower gas concentrations, the product again corresponds more to a liquid having individual gas bubbles than to a foam. Gas bubble diameters above 50 μm are particularly preferred in the surfactant-containing foam according to the present invention, since the consumer can very effectively perceive bubbles of corresponding size as bubbles; with smaller bubbles this is more difficult, especially from a distance. It is furthermore preferred that the gas bubbles have diameters of less than 1000 μm, in particular less than 800 μm, since smaller bubbles are easier to stabilize. The yield point of the liquid phase necessary for stabilizing small bubbles is lower than for stabilizing larger bubbles. Less thickener or less inorganic salt and optionally co-surfactant accordingly needs to be used (to establish the lower yield point) in order to stabilize smaller bubbles as compared with larger gas bubbles. Accordingly, the gas bubbles of the foam preferably have a diameter from 10 μm to 3 mm, preferably from 20 to 1000 μm, more preferably from 50 to 800 μm, and in particular from 100 to 500 μm.

Surfactant-containing foams in which at least 70% of all foam bubbles have a size from 10 to 1000 μm, in particular from 50 to 500 μm (percentages indicated on a numerical basis) are of particular advantage in terms of both aesthetics and stability.

The gas bubbles of the surfactant-containing foam preferably contain a gas (mixture) comprising air, nitrogen, and/or argon. In the context of this invention the term “gas” also includes mixtures of several gases. It has been found, surprisingly, that the particle size distribution of the gas bubbles within a surfactant-containing foam remains particularly narrow over a period of 4 weeks—i.e. that large bubbles form to a lesser degree—if the gas bubbles of the surfactant-containing foam according to the present invention additionally contain at least one further gas that is insoluble in the liquid phase.

In a further embodiment the gas bubbles of the surfactant-containing foam preferably contain a gas mixture comprising air, nitrogen, and/or argon and additionally at least one further gas that comprises molecules which have a molecular weight greater than 60. In this case as well, large bubbles form to a lesser degree over time in the surfactant-containing foam. These gases are preferably insoluble in the liquid phase.

The gas that is insoluble in the liquid phase and/or that comprises molecules that have a molecular weight greater than 60 can also be a vapor of a substance that is liquid at room temperature, since in the gas mixture, a partial pressure of the insoluble gas which is appreciably below atmospheric pressure is sufficient. The gas phase of the surfactant-containing foam can of course also be made entirely of the insoluble gas.

This gas that is insoluble in the liquid phase and/or that comprises molecules which have a molecular weight greater than 60 is preferably selected from the group that is constituted from sulfur hexafluoride, perfluorocarbons, tetrafluoroethane, tetrafluoropropene, volatile siloxanes, volatile silanes, hydrocarbons, preferably highly branched isohydrocarbons, krypton, xenon, and mixtures of these gases. The gas is preferably selected from the group that is constituted from sulfur hexafluoride, perfluorohexane, tetrafluoroethane, tetrafluoropropene, tetramethylsilane, hexamethyldisiloxane, octamethyltrisiloxane, cyclodecamethylpentasiloxane and cyclooctamethyltetrasiloxane, trimethylpentane, krypton, xenon, and mixtures of these gases.

The surfactant-containing foam can be further stabilized by the addition of solid particles, preferably hydrophobically modified silica particles and/or poorly soluble surfactants. Without wishing to be confined to one theory, the solid particles coat the surface of the gas bubbles and stiffen them, contributing to a further stabilization of the surfactant-containing foam. A surfactant-containing foam in which the surfaces of the gas bubbles are coated with solid particles, in particular hydrophobically modified silica particles, and particularly preferably with polydimethylsiloxane-functionalized silica particles, is accordingly particularly preferred. The quantitative proportion of solid particles in terms of the liquid phase is preferably 0.05 to 5 wt %, preferably 0.1 to 2 wt %.

Further solid particles that can contribute to stabilizing the surfactant-containing foam are preferably cationic particles. “Cationic particles” are understood here as those which exhibit a positive zeta potential under the relevant pH conditions. Methods for measuring the zeta potential of particles are known to one skilled in the art.

Without being limited to one theory, anionic surfactant present in the liquid phase adsorbs onto the cationic particles, resulting in hydrophobization of the particles and thus in interfacial activity thereof.

Hydrotalcite, preferably in a quantitative proportion of 0.1 to 2 wt % in terms of the liquid phase, is used with particular preference. Aluminum oxide particles are also suitable for stabilizing the surfactant-containing foam. A surfactant-containing foam that contains hydrotalcite particles and/or aluminum oxide particles is accordingly preferred.

It is alternatively possible to achieve further stabilization of the surfactant-containing foam thanks to the presence in the liquid phase of fatty alcohols having an alkyl chain of at least 14 carbon atoms. A surfactant-containing foam that contains fatty alcohols having alkyl chains having at least 14 carbon atoms is therefore preferred. n-Fatty alcohols are preferably used in this context. The surfactant-containing foam particularly preferably contains n-fatty alcohols having 14 to 26 carbon atoms in the alkyl chain.

For stabilization reasons, the surfactant-containing foam preferably contains 0.1 to 5 wt %, by preference 0.2 to 4 wt %, particularly preferably 0.3 to 3 wt %, and in particular 0.4 to 2 wt % (based on the liquid phase) of one or more fatty alcohols) having alkyl chains having at least 14 carbon atoms, in particular of the fatty alcohols tetradecanol and/or hexadecanol. Further carbon chains can of course be contained in these raw materials when technical grades are used.

A further possibility for long-term stabilization of surfactant-containing foams has been discovered in the context of the use of hydroxystearic acid. The surfactant-containing foam preferably contains hydroxystearic acid, by preference in a quantity from 0.05 to 2 wt % and in particular in a quantity from 0.1 to 1 wt %, based on the liquid phase.

A further possibility for long-term stabilization of the foam consists in the use of surfactants that, under the conditions of the liquid phase of the foam, are insoluble and are present in the form of particles or phase-separated droplets. One example of such a surfactant is octadecyl pentaglycoside. The surfactant-containing foam preferably contains one or more surfactants that, under the conditions of the liquid phase of the foam, are insoluble and are present in the form of particles or phase-separated droplets; particularly preferably the surfactant-containing foam contains octadecyl pentaglycoside.

The pH of the surfactant-containing foam is preferably 6 to 9, and in particular 7 to 8.

The surfactant-containing foam is preferably a washing or cleaning agent, in particular a heavy-duty laundry detergent, a light-duty laundry detergent, a cleaner for hard surfaces, a toilet cleanser, a cleaner for automatic dishwashing or manual dishwashing, or a treatment agent for laundry.

The surfactant-containing foam accordingly preferably contains, in addition to the surfactant, further ingredients that further improve the applications-engineering and/or aesthetic properties of the washing or cleaning agent. In the context of the present invention the surfactant-containing foam preferably additionally contains one or more substances from the group of builders, bleaching agents, enzymes, soil-release-enabling polymers, electrolytes, pH adjusting agents, perfumes, perfume carriers, fluorescence agents, dyes, hydrotopes, silicone oils, anti-redeposition agents, complexing agents, anti-gray agents, shrinkage preventers, wrinkle-prevention agents, color transfer inhibitors, antimicrobial active substances, nonaqueous solvents, germicides, fungicides, antioxidants, preservatives, corrosion inhibitors, antistatic agents, acids, salts, bittering agents, ironing adjuvants, proofing and impregnation agents, skin-care active substances, swelling and anti-slip agents, softening components, bleach, bleach catalysts, and UV absorbers.

Anionic surfactants, nonionic surfactants, cationic surfactants, amphoteric surfactants, or also mixtures of these surfactants, can be contained in the surfactant-containing foam. The surfactant contained in the liquid phase of the surfactant-containing foam is preferably selected from the group that is constituted from alkyl polyglycosides, betaines, alkoxylated, preferably ethoxylated or ethoxylated and propoxylated fatty acid alkyl esters, amine oxides, in particular alkylamine oxides, alkyl sarcosinates and other surfactants having amino acid-based head groups, polyhydroxy fatty acid amides, fatty acid amides, alkoxylated fatty acid amides, fatty acid ethanolamides, alkoxylated, advantageously ethoxylated, in particular primary alcohols having preferably 8 to 18 carbon atoms and an average of 1 to 12 mol ethylene oxide (EO) per mol of alcohol, alkylbenzenesulfonates, in particular linear alkylbenzenesulfonates, olefinsulfonates, alkanesulfonates, fatty alcohol sulfonates, fatty alcohol ether sulfates, estersulfonates, sulfated fatty acid glycerol esters, salts of alkylsulfosuccinic acid, fatty acid soaps, alkyl phenol polyglycol ethers, alkylbenzenesulfonic acids neutralized with monoethanolamine, fatty acids neutralized with monoethanolamine, and mixtures of these surfactants.

In an embodiment, the surfactant-containing foam represents a washing agent that contains one or more components from the group of builders, complexing agents, perfumes, dyes, optical brighteners, bleaching agents, and color transfer inhibitors.

In another embodiment the surfactant-containing foam represents a washing agent that contains lipase, mannanases, and/or pectate lyase.

In a further embodiment the surfactant-containing foam represents a washing agent that contains citric acid or citrate.

In a further embodiment the surfactant-containing foam represents a cleaner for hard surfaces which contains acid, scents, and/or complexing agents.

In a further embodiment the surfactant-containing foam represents a cleaner for hard surfaces which contains bleaching agent, in particular chlorine bleaching agent.

In a further embodiment the surfactant-containing foam represents a manual dishwashing agent that contains perfume, salts, and furthermore surfactant from the group that is constituted from fatty alcohol sulfate, amine oxide, betaine, alkyl polyglycoside, fatty alcohol ether sulfate, linear alkylbenzenesulfonate, alkanesulfonate, and mixtures thereof. This foam preferably contains 10 to 40 wt % surfactant.

In a further embodiment the surfactant-containing foam represents a cleaner for hard surfaces which contains one or more components from the group that is constituted from corrosion inhibitors, complexing agents, bleach, bleach catalysts, enzymes, polymers, builders, and mixtures thereof.

In a further embodiment the surfactant-containing foam represents a cleaner for hard surfaces which contains acid, preferably amidosulfonic acid, hydrochloric acid, citric acid, lactic acid, formic acid, and/or acetic acid, and furthermore preferably corrosion inhibitors and/or polymers.

In a further embodiment the surfactant-containing foam represents a cleaner for carpets which contains bleach and solvents.

In a further embodiment the surfactant-containing foam represents a shampoo, a hair coloring agent or hair toner, a hair therapy, a cleaning or care-providing product for the human skin, or a cleaning or care-providing product for animal hair.

Preferred embodiments of the surfactant-containing foam contain 2 to 40 wt % surfactant in the liquid phase.

In preferred embodiments the surfactant-containing foam represents a washing agent whose liquid phase contains at least 10 wt %, preferably at least 15 wt %, in particular at least 20 wt % surfactant.

In another embodiment the surfactant-containing foam represents a cleaner for hard surfaces whose liquid phase contains a maximum of 15 wt %, preferably a maximum of 10 wt % surfactant.

The liquid phase of the surfactant-containing foam contains preferably 20 to 98 wt %, by preference 25 to 85 wt %, and in particular 30 to 70 wt % water. The fact that in the surfactant-containing foam, the gas can replace portions of the water contained in a comparable liquid or gelled agent, with no change in the quantity of surfactant and of other active agents in the respective liquid agents, represents a decided advantage of the surfactant-containing foam with respect to a usual liquid or gelled agent. For example, a specific volume of a liquid washing agent contains 60% by volume water, while the surfactant-containing foam, for the same concentration of surfactant and further ingredients, comprises only 30% by volume water and also 30% by volume gas. The foam is thus, in terms of weight, more concentrated and therefore more efficient and economical; or, in terms of formulation, it is lighter and thus more economical and more convenient for the consumer to transport. A further advantage of the present invention is thus the fact that the water content of surfactant-containing agents can be lowered, which is unquestionably of economic and environmental interest.

The surfactant-containing foam is, with the exception of the gaseous constituents, preferably water-soluble or water-dispersible. If this is the case it is possible to ensure that all the constituents of the surfactant-containing foam, with the exception of the gaseous constituents, are available to clean or provide care to the treated surface. As also already indicated by the definition of the surfactant-containing foam as a dispersed system of gas in a liquid phase, the present invention does not relate to foams having permanent cell walls, which furthermore may not be water-soluble or water-dispersible and thus function merely as carriers, similar to a sponge, that transport active-agent-containing preparations.

The surfactant-containing foam is preferably flowable or pourable, so that it can be dispensed-poured-out of a reservoir bottle. The surfactant-containing foam itself preferably has a viscosity from 0.5 to 50 Pas at a shear rate of 10 s⁻¹ and a temperature of 20° C. The viscosity of the surfactant-containing foam is determined using the same experimental setup as described above for the viscosity of the liquid phase, but a plate/plate measuring system using cross-corrugated plates is used in order to prevent the surfactant-containing foam from “slipping out” (gap width=1500 μm).

Dispensing of a surfactant-containing foam from a deformable package or a deformable plastic bottle is particularly effectively possible when this viscosity is present.

The surfactant-containing foam can be manufactured using methods known to one skilled in the art. A preferred method for manufacturing the surfactant-containing foam is one in which a surfactant-containing liquid phase is foamed by introducing gas into the liquid phase, by passing the liquid phase through a gas, or mechanically.

Particularly preferably, the surfactant-containing liquid phase is foamed using a gas mixture comprising air, nitrogen, and/or argon as well as preferably at least one further gas that has a molecular weight greater than 60 and that preferably is insoluble in the liquid phase.

In a particularly preferred embodiment, a dynamic foam generator using the rotor-stator principle is used for foaming. Foam generators of this kind allow further components to be delivered via dispensing systems, and allow the gas bubble size to be adjusted based on the energy input. Depending on the embodiment of the apparatus, the quantity to be continuously produced is between 1 kg/h and 5000 kg/h of foam. Because the gas for foaming can be selected without restriction, with corresponding apparatuses it is possible, with little outlay, to utilize gas mixtures that, for example, comprise a gas that is insoluble in the liquid phase. Corresponding apparatuses can be combined with a test gas generator and gas mixing system.

The liquid phase of the surfactant-containing foam is manufactured by means of usual and known methods and processes.

Also a subject of the present invention is a packaged product comprising a surfactant-containing foam whose liquid phase exhibits a yield point.

The surfactant-containing foam is preferably packaged so that the consumer can recognize the cell structure of the surfactant-containing foam without needing to open the package for that purpose. The material of the package is therefore preferably transparent at least in a certain proportion. “Transparent” is to be understood for purposes of this invention to mean that the transmittance within the visible spectrum of light (410 to 800 nm) is greater than 20%, preferably greater than 30%, extremely preferably greater than 40%, and in particular greater than 50%. As soon as a wavelength of the visible spectrum of light exhibits a transmittance greater than 20%, it is to be regarded as transparent for purposes of the invention.

In an embodiment of the present invention, the packaged product comprising the surfactant-containing foam is a single-use portion, in particular a pouch, whose envelope is preferably entirely or partly water-soluble and with particular preference is transparent.

Suitable materials for the entirely or partly water-soluble envelope are in principle all materials that can entirely or partly dissolve in an aqueous phase under the conditions existing in a washing operation, dishwashing operation, or cleaning operation (temperature, pH, concentration of components having washing activity). The polymer materials can particularly preferably belong to the groups of (optionally partly acetalized) polyvinyl alcohol, polyvinylpyrrolidone, polyethylene oxide, gelatin, cellulose and derivatives thereof, starch and derivatives thereof, in particular modified starches, and mixtures (polymer blends, composites, co-extrudates, etc.) of the materials recited. Gelatin and polyvinyl alcohols, as well as the two aforesaid materials each in combination with starch or modified starch, are particularly preferred. Inorganic salts and mixtures thereof are also appropriate as materials for the at least partly water-soluble envelope.

If the envelope or package of the surfactant-containing foam is transparent, the liquid phase of the surfactant-containing foam preferably contains a stabilizing agent that stabilizes the ingredients with respect to breakdown and deactivation phenomena due to light irradiation. Antioxidants, UV absorbers, and fluorescent dyes have proven particularly suitable here.

It is also preferred if the surfactant-containing foam represents only one phase of a multi-phase agent. For example, pouches comprising multiple compartments, one or more of which contain a foam, if possible at least two foams in different colors, are particularly preferred. Also possible is the combination of a surfactant-containing foam encased in a transparent film with a compressed tablet or a cast shaped element.

A packaged product that is a container comprising surfactant-containing foam for multiple uses is particularly preferred. This container preferably accommodates a volume from 20 to 2000 ml, in particular from 50 to 1000 ml.

This container is preferably a transparent container, in particular a transparent plastic or glass container, in particular a transparent glass or plastic bottle.

The use of a glass container, for example a glass bottle, is preferred in particular for the instances in which the surfactant-containing foam is a cosmetic product, for example a shampoo or a bath additive.

If the container is a plastic bottle, the latter is particularly preferably deformable, preferably so that its contents can be “squeezed” out.

A preferred subject of the present invention is a packaged product in the form of a transparent, preferably deformable plastic bottle comprising a surfactant-containing foam whose liquid phase exhibits a yield point.

This bottle can have the spout or outlet valve above the reservoir, or can also be embodied so that the reservoir is located above the outlet valve of the dispensing bottle (upside-down bottle).

An example of a preferred packaged product is a transparent bottle in which two or three surfactant-containing foams of differing colors are present in marbled fashion.

It is likewise possible for the container comprising surfactant-containing foam for multiple uses to be a tube.

### EXAMPLES

### Example 1

A washing agent having the following composition was produced:

| | Vi | E1 |
|---|---|---|
| C₁₂₋₁₈—ROH•7 EO | 4 | 2 |
| Sodium lauryl ether sulfate•2 EO | 8 | 8 |
| C₁₂₋₁₈ fatty acid, sodium salt/C₁₂₋₁₈ fatty acid | 1 | 1 |
| Linear C₉₋₁₃ alkylbenzenesulfonic acid, Na salt | 4 | 4 |
| Phosphonic acid, Na salt | 0.8 | 0.8 |
| Optical brightener | 0.1 | 0.1 |
| Citric acid, Na salt | 2.5 | 2.5 |
| Sodium metaborate | 1.1 | 1.1 |
| Ethanol | 3 | 3 |
| Enzymes | 1.8 | 1.8 |
| Perfume | 0.2 | 0.2 |
| Dye | 0.001 | 0.001 |
| NaCl | 0 | 3 |
| i-C₁₃—ROH•3 EO | 0 | 4 |
| Water | to 100 | to 100 |
| Yield point exists? | no | yes |

All indications in wt %

The formulation E 1 according to the present invention represented a lamellar phase and exhibited a yield point. The comparative formulation V 1 was an isotropic L 1 phase with no yield point.

Both formulations were whipped up, using a laboratory apparatus for foam generation (rotor of a Sita 82000 foam tester), into a flowable foam that was made up of 60% by volume liquid phase and 40% by volume air.

The comparative formulation V 1 separated within a few hours into a liquid phase and a more arid foam phase. The formulation E 1 according to the present invention exhibited no leakage of the foam and no separation of a liquid phase upon storage at room temperature over a period of several weeks. Only an increase in bubble size was observed. The visual impression of a single-phase foam was, however, maintained.

### Example 2

2 wt % n-hexadecanol (formulation E 2) was stirred at 60° C. into the formulation E 1 according to the present invention. Formulations E 1 and E 2 were then foamed up at 50 to 60° C., as described in Example 1, into a foam made up of 60% by volume liquid phase and 40% by volume air.

The initial bubble size distribution of the foams was identical. The foams were then cooled to room temperature and decanted into cuvettes for photographic observation of bubble size. After storage for four weeks at 20° C., the foam of formulation E 2 exhibited an appreciably narrower gas bubble distribution than the foam of formulation E 1.

### Example 3

The liquid formulation E 1 from Example 1 was foamed in two ways:

### Example 3.1

With air, corresponding to E 1.

### Example 3.2

With air that had previously been passed through a gas washing bottle that contained perfluorohexane that is liquid at room temperature (E 3). The maximum perfluorohexane content of the gas mixture used for foaming thus corresponds to the saturation vapor pressure of perfluorohexane at 20° C.

Both foams were stored for nine weeks at 20° C.

### Example 3.1

In the foam that had been foamed using air, all the bubbles exhibited a diameter of less than 0.2 mm.

### Example 3.2

In the foam that had been foamed using the air/perfluorohexane mixture, at least 10% by volume of the gas enclosed in the foam is present in the form of bubbles having a diameter of between 1 and 2 mm.

It was thus possible to observe that the foam E 3 of Example 3.1 exhibited almost no enlargement over nine weeks, whereas the foam E 1 of Example 3.2 displayed considerable growth of the gas bubbles over the same time.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A surfactant-containing foam whose liquid phase exhibits a yield point.

2. The surfactant-containing foam according to claim 1, wherein the yield point of the liquid phase is at least 0.1 Pa.

3. The surfactant-containing foam according to claim 1, wherein the liquid phase intrinsically exhibits a viscosity from 0.1 to 50 Pas at a shear rate of 10 s⁻¹ at a temperature of 20° C.

4. The surfactant-containing foam according to claim 1, wherein the liquid phase contains one or more thickeners and/or is present in the form of a liquid-crystal surfactant phase.

5. The surfactant-containing foam according to claim 1, wherein the foam contains 10 to 60% by volume gas and 40 to 90% by volume liquid phase.

6. The surfactant-containing foam according to claim 1, wherein the gas bubbles of the foam have a diameter from 10 μm to 3 mm.

7. The surfactant-containing foam according to claim 1, wherein the surfaces of the gas bubbles are coated with solid particles, and the foam comprises one or more additives selected from the group consisting of: fatty alcohols having alkyl chains having at least 14 carbon atoms; hydroxystearic acid; hydrotalcite; aluminum oxide; and surfactants that, under the conditions of the liquid phase of the foam, are insoluble and are present in the form of particles or phase-separated droplets.

8. The surfactant-containing foam according to claim 1, wherein the liquid phase contains 2 to 40 wt % surfactant.

9. The surfactant-containing foam according to claim 1, wherein the liquid phase contains 20 to 98 wt % water.

10. The surfactant-containing foam according to claim 1, wherein the foam, with the exception of the gaseous constituents, is water-soluble or water-dispersible.

11. The surfactant-containing foam according to claim 1, wherein the foam has a viscosity from 0.5 to 50 Pas at a shear rate of 10 s⁻¹ at a temperature of 20° C.

12. A method for manufacturing a surfactant-containing foam according to claim 1, in wherein a surfactant-containing liquid phase is foamed by introducing gas into the liquid phase, by passing the liquid phase through a gas, or mechanically.
